(19) United States
(12) Patent Application Publication
(10) Pub. No.: US 2005/0242698 A1
(43) Pub. Date: Nov. 3, 2005

(54) Color cathode ray tube having uv-reflective coating

(75) Inventors: Hans-Helmut Bechtel, Roetgen (DE); Wolfgang Busselt, Roetgen (DE); Joachim Opitz, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/511,809

(22) PCT Filed: Apr. 16, 2003
(86) PCT No.: PCT/IB03/01513

§ 371 Date: Oct. 19, 2004

(30) Foreign Application Priority Data
Apr. 23, 2002 (DE) 102 17 981.6

(51) Int. Cl. H01J 29/10; H01J 29/88

(52) U.S. Cl. 313/461; 313/479; 313/467

(57) ABSTRACT

A color cathode ray tube, that is fitted with a color screen that comprises a glass face panel, a phosphor coating UV-reflective layer that is arranged between the glass face panel and the phosphor coating, the UV-reflective layer containing colloid particles of an oxygen-containing material, having a grain size d<400 nm.

The invention relates to a color cathode ray tube, fitted with a color screen that comprises a glass face panel, a phosphor coating and a UV-reflective layer between the glass face panel and the phosphor coating.

To generate visible light from the electron beam of a color cathode ray tube, what is needed is a color screen in the material of which conversion of the electron energy into visible light is triggered by processes in atomic physics. For this purpose, the color screen contains, in a phosphor coating, appropriate phosphors that luminesce in the colors red, green and blue when struck by the electron beam.

The phosphor coating contains the phosphors in the form of phosphor triplets laid out in a grid pattern—the phosphors generally being in line form but also, in older picture tubes and high-resolution monitor tubes, in dot form.

In principle, this grid pattern is produced photolithographically, i.e. by a photochemical process using ultraviolet light. The green-luminescing phosphor for example may be applied first. The phosphor is suspended in a suitable light-sensitive resist and applied to the screen. The light-sensitive resist is cured by irradiation with UV-light by cross-linking the chains of molecules, so that when the layer is subsequently developed the phosphor will be left adhering at the exposed points. By means of a mask and the UV-light-source, the screen is irradiated only at the points at which it is intended the grains of the green-luminescing phosphor will be left adhering. The phosphor is then washed off again at the unexposed points. The grid of green-luminescing phosphor is first produced in this way. The blue-luminescing and red-luminescing grid patterns are then applied in the same way. For this purpose, the mask or the UV-source are moved slightly in each case.

There are problems with the highly accurate reproduction of very fine grid structures for high-resolution screens. A factor which, amongst others, plays a part here is the exact dosage of the UV-radiation in the photolithographic process. Too low a UV-dosage does not fully cure the light-sensitive resist and the phosphor fails to adhere. Too high a UV-dosage produces grid-pattern structures that are enlarged beyond the exposed areas, as a result of which the purity of the colors on the color screen suffers.

It is known that the dosage of the UV-light can be more satisfactorily controlled if the trapping of light by the background below the phosphor coating, i.e. the glass face panel, is reduced by mirrors or UV-reflective layers. Known from U.S. Pat. No. 6,013,978, for example, is a color cathode ray tube that comprises a glass face panel and a phosphor coating on the glass face panel, there being arranged between the face panel and the phosphor coating a UV-reflective coating that is transparent to visible light. The UV-reflective coating may comprise layers that have alternately high and low refractive indexes.

A disadvantage of a UV-reflective coating that comprises a plurality of layers that have alternately high and low refractive indexes is that such sequences of layers are time-consuming and expensive to produce.

It is an object of the present invention to provide a color cathode ray tube having a UV-reflective layer, for which the manufacturing process is inexpensive and that can be incorporated in the conventional process of manufacture.

In accordance with the invention, this object is achieved by a color cathode ray tube that is fitted with a color screen that comprises a glass face panel, a phosphor coating, and a UV-reflective layer that is arranged between the glass face panel and the phosphor coating, wherein the UV-reflective layer contains colloid particles of an oxygen-containing material, having a grain size d<400 nm.

The UV-reflective layer improves the adhesion of the phosphor in the phosphor coating because the UV-radiation required for the photolithographic production of the coating can be more satisfactorily dosed. The desired effect is achieved by the layer having colloid particles of an oxygen-containing material, having a grain size d<400 nm, because short-wave light such as UV-light is scattered to a considerably greater degree by this layer than longer-wave visible light (Mie scattering). Hence, the UV-reflective layer that contains colloid particles of an oxygen-containing material, having a grain size d<400 nm, remains transparent to visible light.

A consequence of the increasing reflection at shorter wavelengths is that there is preferential emission of the red part of visible light in the color cathode ray tube according to the invention. As a result, the proportions of beam current for red, green and blue light that are required to produce white light are evened up—a highly desirable side-effect.

The thickness s of the UV-reflective layer is usually between 0.5 and 10 μm.

In a preferred embodiment of the invention, the mean grain size d₅₀ of the colloid particles is less than 200 nm.

It is especially preferred for the grain-size distribution to be heterodisperse. This improves the scattering of the incident light.

It is advantageous if the oxygen-containing material of the colloid particles is selected from the group of oxides having the general formula M¹₂O₃ where M¹=B, Al, Sc, La or Y, and having the general formula M²O₂ where M²=Si, Ge, Sn, Ti, Zr or Hf, and from the group of phosphates having the general formula M³ₓPO₃ where M³=Li, Na or K and 0<x≦1, and having the general formula M¹PO₄ where M¹=B, Al, Sc, La or Y.

The oxygen-containing materials do not absorb visible light and can readily be produced as colloid particles of a grain size d<400 nm.

What may be used with particular advantage as an oxygen-containing material is SiO₂.

It is also preferred for the mean refractive index of the UV-reflective layer in the visible range of the spectrum to be smaller than the refractive index of the material of the glass face panel. Under this condition, the UV-reflective layer, as seen by the viewer, also acts as a reflection-reducing layer for visible light and reduces the irritating reflections of ambient light at the inner face of the glass face panel.

These and other aspects of the invention are apparent from and will be elucidated with reference to the embodiments described hereinafter.

A color picture tube comprises the so-called electron gun having the beam generating and focusing system for the three primary colors red, green and blue, together with a beam deflection system and the color screen, in an evacuated envelope. There is a screen coating on the inside face of the color screen.

The screen coating is generally composed of a plurality of layers. The layer that contains the phosphors generally comprises a regular grid of color dots or color lines that, when excited by an electron beam, luminesce in their primary colors red, green and blue.

The screen coating of the color cathode ray tube according to the invention also has, between the glass face panel and the phosphor coating, a UV-reflective coating.

The makeup of the screen coating may also comprise further layers, e.g. a black matrix layer and rear-face metallization.

For the UV-reflective layer, colloid particles of an oxygen-containing material, having a grain size d<400 nm, which increase the reflection of UV-light at the inside face of the glass face panel, are applied in a separate layer between the phosphor coating and the inside face of the glass face panel. As well as by the fact that they reflect UV well, the materials that are suitable for the UV-reflective layer are also determined by their optical transparency. There are various materials and combinations of materials that can be used, in which case layer thickness of up to 1 μm. are employed.

The colloid particles for the UV-reflective layer are preferably of an approximately spherical shape.

The particle diameter d is less than 400 nm and it is preferable for the mean particle diameter to be d₅₀<200 nm.

The colloid particles may either be of a uniform grain size, i.e. monodisperse, or else may be heterodisperse. What are preferred are heterodisperse grain-size distributions with a wide distribution of grain-sizes that covers both very small particles having a mean grain size d₅₀<100 nm and large particles having a mean grain size d₅₀>100 nm.

What are preferred as materials for the colloid particles are oxygen-containing inorganic materials selected from the group of oxides and phosphates. What are particularly suitable as the oxygen-containing material of the colloid particles are the oxides having the general formula M¹₂O₃ where M¹=B, Al, Sc, La or Y, or having the general formula M²O₂ where M²=Si, Ge, Sn, Ti, Zr or Hf, and the phosphates having the general formula M³ₓPO₃ where M³=Li, Na or K and 0<x≦1 or having the general formula M¹PO₄ where M¹=B, Al, Sc, La or Y.

The UV-reflective layer preferably contains a colloidal SiO₂, that is to say finely divided SiO₂ with a mean particle size 50 nm<d<150 nm corresponding to a specific surface area of 25 m²/g<As<70 m²/g.

Examples of finely divided SiO₂ colloids having a mean particle size 50 nm<d<150 nm corresponding to a specific surface area of 25 m²/g<As<70 m²/g are NYACOL® 9950 (Akzo Nobel): As=27 m²/g, LEVASIL® VPAC4056 (Bayer): As=50 m²/g, SYTON®W (DuPont de Nemours): As=70 m²/g, MONOSPHER® 100 (E.Merck), MONOSPHER® 150 (E. Merck). What is preferred is a fine divided SiO₂ colloid of the polydisperse type but it is also possible for a finely divided SiO₂ colloid of the monodisperse type to be used.

Use may also be made of colloid particles of organic compounds such as polymethyl methacrylate, polystyrene, polyurethane, benzoguano amine resin and silicone resin.

In one embodiment of the invention, the screen coating for the color cathode ray tube according to the invention having the UV-reflective layer may be produced by the following method steps:

cleaning of the surface of the glass face panel

application of a textured black matrix layer

application of a dispersion of colloid particles in a solvent together with a polymeric binder, which dispersion contains the colloid particles and the polymeric binder in proportions by weight of from 10:1 to 1:10, by dipping, spraying, rolling, spin-on coating or printing.

centrifuging off of excess solution

drying at 40° C.

production of one or more phosphor layers by a wet-chemical photolithographic process such as patch coating, flowcoating or similar processes

drying at 40° C.

exposure by UV-light

development of the exposed layer, e.g. by pressure flushing

drying at 40° C.

firing on of the screen coating at 400° C. accompanied by burning off of the organic polymers.

To produce the color cathode ray tube, the glass face panel is, if required, first coated by a photolithographic process with the pattern of a black matrix.

The subsequent process by which the UV-reflective layer is produced will generally depend on the photolithographic process by which the phosphor layers subsequently to be arranged above it are to be produced.

For this purpose, a suitable dispersion of the colloid particles in a solvent is first produced. As well as the solvent and a binder, the dispersion may also contain various additives to affect the colloidal stability of the dispersion.

It is preferable for the water-soluble polymer used in the photolithographic process also to be used as an intermediate binder for the colloid particles of the UV-reflective layer.

Because the phosphors are usually applied in a suspension of the photoresist polyvinyl alcohol/ammonium dichromate and are then structured by photolysis, the colloids are applied in a dispersion in polyvinyl alcohol and water for the UV-reflective layer too when this is the case

The PVA/ADC photoresist system may, however, also be replaced by other photoresist systems that contain other water-soluble photosensitive polymers, such as, for example, PVA derivatives having chromophoric side-groups that cause the cross-linking. In this case, the UV-reflective layer is preferably applied with the same water-soluble photosensitive polymers as the phosphor coating. Intermediate polymers that improve the initial adhesion are in each case formed between pairs of layers.

The colloid particles may, however, also be applied with a different organic polymer binder, that is burnt off when the screen is subsequently fired on.

Additives to affect the colloidal stability are electrostatic and steric dispersants such as, for example, Dolapix (Zschimmer), Dispex A40 (Allied Colloids) or Disperbyk (BYK Chemie). Electrolytes may also be used to affect colloidal stability such as, for example, ammonium halides and ammonium nitrate, tetramethyl ammonium salts, tetraethyl ammonium salts or salts of simple organic acids such as acetates, citrates, oxalates or tartrates.

The suspensions may also be mixed with additives that affect their rheological properties.

The layer having the colloid particles is applied by dipping, spraying, rolling spin-on coating, curtain coating or printing, thus giving a regular layer thickness.

The layer thickness is set, by the solids content and viscosity of the suspension and the parameters of the coating process, in the range from 0.5 to 10 μm

The wet layer is then dried by recirculated air, heat or infrared radiation.

The grids of the three primary colors blue, red and green are then applied by the known method in three successive photolithographic steps, using suspensions of pigmented phosphors. Alternatively, the phosphors may also be applied by a printing process.

The main purpose of the thermal post-treatment of the screen coating is to remove the additives from the different layers. The additives used, i.e. electrolytes, dispersants and polymeric binders can be removed without leaving any residue by heating to 400 to 450° C.

### EMBODIMENT 1

The production of the screen begins with a 17″ glass face panel that comprises a 2 cm thick glass plate. This is cleaned and dried and then, to give a black matrix, is coated with a 50 nm thick layer of Fe₂O₃ pigments and dried at 120° C.

It is then coated with a positively photosensitive photoresist and exposed as dictated by the positions of the red, blue and green-emitting phosphor subpixels. By developing it, the photoresist is removed at the points that were not exposed. A black layer comprising graphite pigments and binder is then applied and dried at 60° C. By the use of acids, the photoresist and the black layer carried on it are removed at the positions of the subpixels.

This glass face panel carrying the black matrix layer is washed with de-ionized water and then dried.

For the UV-reflective layer, a coating dispersion of aluminum oxide, ammonium acetate and PVA solution is prepared in water.

For this purpose, 150 g of aluminum oxide produced by flame pyrolysis is slowly stirred into a 0.005 molar solution of ammonium acetate in 500 g of distilled water at room temperature. Once all the colloid particles have been added, the suspension is dispersed for 15 min in an ultrasonic bath.

The dispersed suspension is mixed with 25 ml of a 4.7% aqueous solution of polyvinyl acetate while being stirred.

50 ml of this coating solution is applied by the spin-on process at 200 rpm. Having been coated in this way, the glass face panel is dried for 10 min at 40° C.

The screen is then coated with the phosphor preparation by the flowcoating process. For this, the phosphor preparation containing a phosphor emitting in one color is suspended in a binder solution activated with ammonium dichromate (ADC). The individual components of the phosphor suspension, i.e. powdered phosphor, water, binder, dispersant, stabilizer and photosensitive component are mixed, as a function of the particular phosphor and the processing conditions, in a preset sequence and concentration given by a defined formulation. The suspension of the phosphor preparation is applied to the inside face of the prepared glass screen panel, which is rotating in the flowcoating machine. The rotation of the screen causes the phosphor suspension to become evenly distributed on it. Excess suspension is centrifuged off. The wet layer of phosphor that has formed is dried. A shadow mask is mounted on the inside face of the glass screen panel at some distance from the phosphor layer. The phosphor layer is irradiated with ultraviolet light through this shadow mask, as a result of which the irradiated areas of the phosphor layer are cured. The phosphor layer is developed with hot water, i.e. the uncured parts of the phosphor layer are removed. The structured phosphor layer is dried.

The above process steps are performed in succession with three phosphor preparations containing phosphors of the emission colors green, blue and red. The screen is then lacquered with a thin film of acrylate and a 200 nm thick layer of aluminum is then vapor deposited on it. The screen is then fully heated at approx. 440° C. to remove any remaining organic components.

A color cathode ray tube produced in this way is of increased efficiency and has an improved LCP (luminance contrast performance).

### EMBODIMENT 2

The production of the screen begins with a 17″ glass face panel that comprises a 2 cm thick glass plate. This is cleaned and dried and then, to give a black matrix, is coated with a 50 nm thick layer of Fe₂O₃ pigments and dried at 120° C.

It is then coated with a positively photosensitive photoresist and exposed as dictated by the positions of the red, blue and green-emitting phosphor subpixels. By developing it, the photoresist is removed at the points that were not exposed. A black layer comprising graphite pigments and binder is then applied and dried at 60° C. By the use of acids, the photoresist and the black layer carried on it are removed at the positions of the subpixels.

This glass face panel carrying the black matrix layer is washed with de-ionized water and then dried.

For the UV-reflective layer, a coating dispersion of silicic acid, ammonium chloride and PVA solution is prepared in water.

For this purpose, 200 g of pyrogenic silicic acid and 21.4 mg of aluminum chloride are slowly stirred into 400 g of distilled water at room temperature. Once all the colloid particles have been added, the suspension is dispersed for 1 h in an ultrasonic bath. The dispersed suspension is mixed, while being stirred, with 5 ml of a 1.0% aqueous polymer solution of Rheovis CRX (Allied Colloids) that has been adjusted to pH 9.5 with ammonia.

50 ml of this coating solution is applied by the spin-on process at 200 rpm. Having been coated in this way, the glass face panel is dried for 10 min at 40° C.

The screen is then coated with the phosphor preparation by the flowcoating process. For this, the phosphor preparation containing a phosphor emitting in one color is suspended in a binder solution photoactivated with ammonium dichromate (ADC). The individual components of the phosphor suspension, i.e. powdered phosphor, water, binder, dispersant, stabilizer and photosensitive component are mixed, as a function of the particular phosphor and the processing conditions, in a preset sequence and concentration given by a defined formulation. The suspension of the phosphor preparation is applied to the inside face of the prepared glass screen panel, which is rotating in the flowcoating machine. The rotation of the screen causes the phosphor suspension to become evenly distributed on it. Excess suspension is centrifuged off. The wet layer of phosphor that has formed is dried. A shadow mask is mounted on the inside face of the glass screen panel at some distance from the phosphor layer. The phosphor layer is irradiated with ultraviolet light through this shadow mask, as a result of which the irradiated areas of the phosphor layer are cured. The phosphor layer is developed with hot water, i.e. the uncured parts of the phosphor layer are removed. The structured phosphor layer is dried.

The above process steps are performed in succession with three phosphor preparations containing phosphors of the emission colors green, blue and red. The screen is then lacquered with a thin film of acrylate and a 200 nm thick layer of aluminum is then vapor deposited on it. The screen is then fully heated at approx. 440° C. to remove any remaining organic components.

A color cathode ray tube produced in this way is of increased efficiency and has an improved LCP.

1. A color cathode ray tube, that is fitted with a color screen that comprises a glass face panel, a phosphor coating and a UV-reflective layer that is arranged between the glass face panel and the phosphor coating, characterized in that the UV-reflective layer contains colloid particles of an oxygen-containing material, having a grain size d<400 nm.

2. A color cathode ray tube as claimed in claim 1, characterized in that the thickness s of the UV-reflective layer is between 0.5 and 10 μm.

3. A color cathode ray tube as claimed in claim 1, characterized in that the mean grain size d₅₀ of the colloid particles is less than 200 nm.

4. A color cathode ray tube as claimed in claim 1, characterized in that the grain-size distribution is heterodisperse.

5. A color cathode ray tube as claimed in claim 1, characterized in that the oxygen-containing material of the colloid particles is selected from the group of oxides having the general formula M¹₂O₃ where M¹=B, Al, Sc, La or Y, and having the general formula M²O₂ where M²=Si, Ge, Sn, Ti, Zr or Hf, and from the group of phosphates having the general formula M³ₓPO₃ where M³=Li, Na or K and 0<x≦1, and having the general formula M¹PO₄ where M¹=B, Al, Sc, La or Y.

6. A color cathode ray tube as claimed in claim 1, characterized in that SiO₂ is used as the oxygen-containing material.

7. A color cathode ray tube as claimed in claim 1, characterized in that the mean refractive index of the UV-reflective layer in the visible range of the spectrum is less than the refractive index of the material of the glass face panel.
